(19) United States
(12) Patent Application Publication
(10) Pub. No.: US 2002/0118657 A1
(43) Pub. Date: Aug. 29, 2002

(54) Systems and methods for communicating with a communications network

(76) Inventors: Diane Winchell, San Diego, CA (US); Jon Korecki, San Diego, CA (US); Miles Kirby, San Diego, CA (US)

Correspondence Address: Qualcomm Incorporated, Patents Department, 5775 Morehouse Drive, San Diego, CA, 92121-1714, US

(21) Appl. No.: 09/796,388

(22) Filed: Feb. 28, 2001

(51) Int. Cl. H04L 12/56

(52) U.S. Cl. 370/329; 370/401

(57) ABSTRACT

A base module provides a plurality of data connections and communications structure to interconnect a wireless communication device with one or more peripheral devices to form a modular system for communicating with a communications network. Some peripheral devices may be integral with the base module while other peripheral devices and the wireless communications device may be detachably connected to the base module to form a portable system. Therefore, the base module, peripherals and wireless communications device define a detachable and interconnectable system for wirelessly communicating with a communications network.

### BACKGROUND OF THE INVENTION

I. Field of the Invention

This invention relates to systems and methods for communicating with a communications network, and, more particularly, to systems and methods for providing wireless access to a communications network.

II. Description of the Related Art

The Internet, including its electronic mail and World Wide Web protocols, is playing an ever-increasing role in the day-to-day activities of individuals. The use of the Internet is expanding with regard to the transfer of information in both business and personal/social settings. As a result of the burgeoning use of the Internet by people all around the world, the demand for access to the Internet in any setting has also risen. In response to this demand for access, solutions have been provided that allow Internet users access the Internet not only from hard-wired connections such as through personal computers at home or at their business, but also through portable, wireless devices such as mobile or satellite phones, personal digital assistants, and other hand-held or pocket-sized electronic devices.

The use of the typical wireless device for Internet access, however, is problematic for most Internet users as these devices are not designed for convenient Internet access. The typical wireless device is “wireless” because it is designed for mobility. A mobile design, driven by the user's demand for portability, typically requires the device to be increasingly smaller and more compact so that it is adapted for the user to unobtrusively carry the device. For example, these wireless devices are generally designed to be hand-held or “pocket-sized” devices, being much smaller than, for example, a typical portable or laptop personal computer. Further, the primary use of these wireless devices is typically for some function other than Internet access. For example, mobile or satellite phones are primarily designed for making and receiving phone calls. In another example, personal digital assistants are designed for storing and retrieving schedules or contacts.

As a result of the primary design and function of the typical wireless device being non-related to Internet access, these devices do not facilitate the convenient and comfortable experience that Internet users enjoy with typical hard-wired devices. For example, the keypads of typical wireless devices usually include very small keys, which may be difficult for a user to type with or even to individually touch. For instance, the keys on a mobile or satellite phone are primarily numeric, with more than one alphabetic character sharing the numeric key. It is therefore a painstaking process to type in words or phrases. Further, for instance, some wireless devices include a stylus or other pointed implement to facilitate contacting the desired key because the contact area of the key, which may be physical or virtual, is so tiny.

In another example, the display associated with the typical wireless device is generally only a couple of dozen characters in width and only a few lines in length, if not smaller. This type of small display makes it difficult to review long messages. Further, the browser or electronic mail software associated with the typical wireless device is a scaled back version of the software used in hard-wired devices having greater memory and processing capabilities. The scaled-back software typically limits the browser or electronic mail to displaying only alphanumeric characters, eliminating the graphical images associated with much of the information sent and received via the Internet. Finally, the typical wireless device is not designed for convenient attachment to peripheral devices, such as displays, keyboards, speakers, etc.

### SUMMARY OF THE INVENTION

In an exemplary embodiment of the invention, a system for communication with a communications network, comprises: a base module including a plurality of communications ports, the plurality of communications ports including a wireless device port and at least one peripheral device port, wherein the wireless device port is operable for providing a communications link with the communications network, and wherein the at least one peripheral device port is operable for providing a communications link to the wireless device port; and at least one peripheral device connectable to the corresponding at least one peripheral device port, the at least one peripheral device providing output data or receiving input data in communication with the communications network through the base module.

In another embodiment, a system for communication with a communications network, comprises: a base module including a plurality of communications ports, the plurality of communications ports including a wireless device port and at least one peripheral port; at least one of a plurality of peripheral devices connectable to the at least one peripheral port, the at least one peripheral device providing output data or receiving input data in communication with the communications network through the base module; and a wireless communications device connectable to the wireless device port, the wireless communications device operable to communicate with the communications network.

In yet another embodiment, a method of interfacing a plurality of peripheral devices with a communications network, comprises: interconnecting a plurality of communications ports mounted within a base module, the plurality of communications ports including a wireless device port and at least one peripheral port, where the wireless device port is operable for providing a communications link with the communications network, and where the at least one peripheral device port is operable for providing a communications link to the wireless device port; and transmitting data for communication with the communications network to and from at least one peripheral device through the base module, the at least one peripheral device connected to the peripheral device port.

A method of interfacing a plurality of peripheral devices with a communications network, comprises: interconnecting a plurality of communications ports mounted within a base module, the plurality of communications ports including a wireless device port and at least one peripheral port, where the wireless device port is operable for providing a communications link with the communications network, and where the at least one peripheral device port is operable for providing a communications link to the wireless device port; transmitting data for communication with the communications network to and from at least one peripheral device through the base module, the at least one peripheral device connected to the peripheral device port; and establishing a communications link with the communications network utilizing a wireless communications device connectable to the wireless device port.

### BRIEF DESCRIPTION OF THE DRAWINGS

FIG. 1 is a block diagram of one embodiment of a system for communicating with a communications network, including a wireless communications device and peripheral devices connected to a base module;

FIG. 2 is a functional block diagram of one embodiment of a method of interfacing a plurality of peripheral devices with a communications network; and

FIG. 3 is a schematic diagram of another embodiment of a system for communicating with a communications network, including a portable base module with an integral display, keyboard and docking port for receiving a wireless communications device, as well as a plurality of attached peripheral devices.

### DETAILED DESCRIPTION OF THE INVENTION

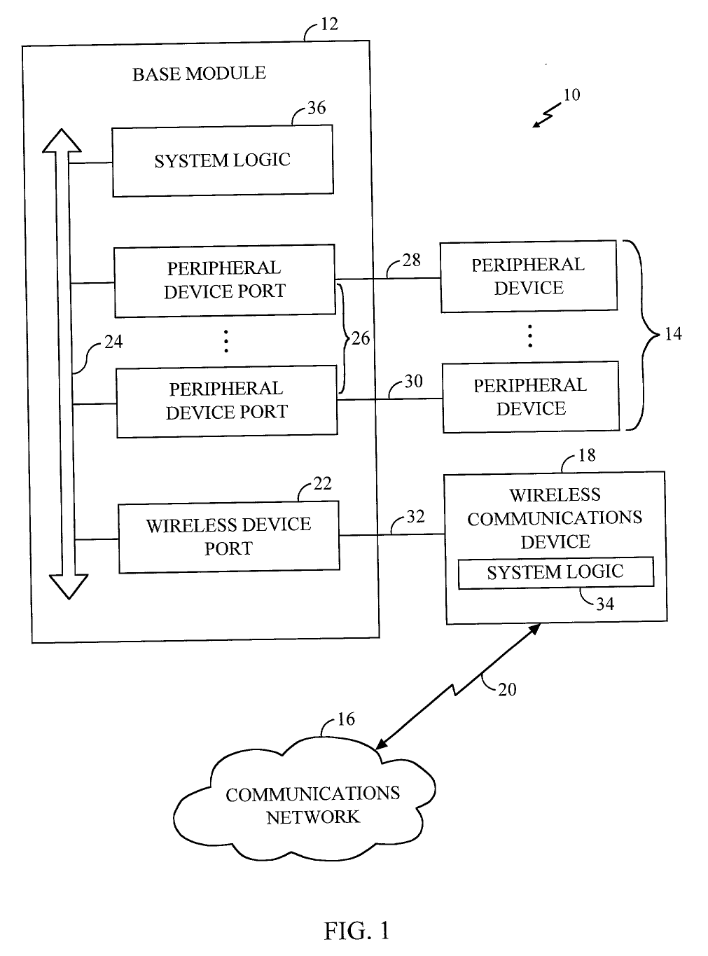

Referring now to FIG. 1, one embodiment of a system 10 for enabling communication with a communications network includes base module 12 exchanging data between plurality of peripheral devices 14 and communications network 16 through wireless communications device 18. Wireless device 18 establishes a wireless connection 20 to communications network 16 and transfers data to and from base module 12 through wireless device port 22 positioned on the base module. Communications bus 24 associated with base module 12 transfers the data between wireless device port 22 and each of plurality of peripheral devices 14 connected to base module 12 through a corresponding plurality of peripheral device ports 26. Connecting devices 28, 30 and 32 respectively may couple the plurality of peripheral devices 14 and the wireless device 18 to the corresponding ports 26 and 22. Software included with wireless device system logic 34 and/or base module system logic 36 enables the data exchange between devices 14 and 18, base module 12 and wireless communications network 16. Thus, base module 12 provides wireless communications device 18 with an interface to any number of peripheral devices 14 for communicating with communications network 16.

Embodiments of system 10 may be used for a variety of wireless communications applications. In one embodiment, for example, system 10 may comprise a mobile webstation where base module 12 and wireless device 18 are portable devices and peripheral devices 14 provide enhanced communications with the communications network 16, such as the Internet. In another embodiment, for example, system 10 may comprise a stationary webstation where base module 12 and peripherals 14 provide a docking station for wireless device 18 to enable wireless communications with communications network 16. In yet another embodiment, for example, system 10 may provide a wireless capability to previously hard-wired applications, such as for providing a land-line connection for a security system or for providing wireless Internet access for a set-top television web device. It should be noted that there are many other applications for system 10 utilizing one or more combinations of the features of system 10 and its components.

Base module 12 includes a housing for mounting ports 22 and 26, communications bus 24 and system logic 36. Base module 12 may be formed of any material for supporting such mountings, such as plastics, composites and metals. Base module 12 may be sized to utilize minimal structure to contain the aforementioned components such that base module 12 is a portable unit. For example, base module 12 may be a hand-held device such as a notebook-sized device or a pocket-sized device for increased portability and mobility.

Ports 22 and 26 are any input- and/or output-type data transfer port that respectively corresponds to an input/output port on wireless device 18 and peripheral devices 14 and/or their respective connecting devices 28, 30 and 32. Suitable examples of ports 22 and 26 include, but are not limited to: USB ports; RS-232 ports; RJ11 ports, light wave or radio wave transmitting and/or receiving devices, etc. Connecting devices 28, 30 and 32 include male/female ports integral with the respective peripheral devices 14 and wireless device 18 or cables with associated connectors for coupling devices 14 and 18 with ports 26 and 22, respectively. Further, connecting devices 28, 30 and 32, in combination with ports 22 and 26 and peripheral devices 14 and wireless device 18, may include light wave or radio wave transmitting and/or receiving devices, such as infrared (IR) devices, radio frequency (RF) devices, and other similar non-contact data transmission devices. Ports 22 and 26 and connecting devices 28, 30 and 32 allow base module 12, peripherals 14 and wireless device 18 to form an interconnected but detachable system. This detachable aspect of the system, in particular combined with the hand-held size of base module 12 and wireless communications device 18, advantageously provide a high degree of portability and mobility to the system.

Communications bus 24 is a network connecting any combination of wireless device port 22, peripheral device ports 26 and system logic 36. Bus 24 allows the transfer of data between the various ports 22 and 26 and/or the system logic 36. For example, communications bus 24 may include a circuit board onto which the ports 22 and 26 and/or system logic 36 are mounted.

Base module 12 may include the appropriate system logic 36, including hardware and software, for wireless communications with communications network 16. For example, system logic 36 may include a communications program for transferring and displaying data between wireless device 18 and communications network 16. Further, for example, system logic 36 may include the appropriate executable programs and drivers enabling data transfer between wireless device 18 and peripheral devices 14 and base module 12 in combination with communications network 16. Additionally, for example, system logic 36 may include one or more browser programs and associated hardware for transferring and displaying data from one or more communications networks 16 accessed through wireless device 18.

Plurality of peripheral devices 14 include any device that may interface with a wireless communications device. Suitable examples of peripheral devices 14 include, but are not limited to, a display, a keypad or keyboard, one or more audio speakers, a printer, a cursor control device such as a mouse or roller ball, an image scanning device, a compact disc read and/or write device, a floppy disk read and/or write device, a memory or storage device, a processor, a set-top television Internet device, a security system, and other similar devices.

Each peripheral device 14 may include one or more predefined features for providing a capability or an improved capability, with respect to the wireless communications device, for communicating with the communications network. The predefined feature may include, for example, a larger keyboard input area, a larger display area, an improved audio system, physical output, image scanning, reading and writing of external data, advanced data storage, advanced processing, wireless communications access, and other similar features.

Peripheral devices 14 may be detachably or integrally connected to base module 12, or peripheral devices 14 may be a combination of detachable and integral devices. For instance, in a portable, notebook-sized system, a display and a keyboard may be integrated into the housing of base module 12, while audio speakers and a printer may be detachable.

Communications network 16 may be any public or private communications network, or a combination of both. Suitable examples of communications network 16 include, but are not limited to: a Public Switched Telephone Network (PSTN), a wireless telephone network or communications system, such as CDMA systems, WCDMA systems, GPRS systems, GSM systems, AMPS systems, and TDMA systems; a satellite telephone network; an optical wave network such as an infrared (IR) network; a radio wave network such as a radio frequency (RF) or microwave network; a Wireless Applications Protocol (WAP) network; the Internet and its various protocols such as the World Wide Web (WWW) and electronic mail; a local area network (LAN); a Wide Area Network (WAN); and BlueTooth™. In general, communications network 16 enables communication between wireless communications device 18 and one or more of: another wireless communications device; a host or server computer; a PSTN telephone; a peripheral device; and any other communications or peripheral device associated with communications network 16.

Wireless communications device 18 includes a mobile telephone such as a QUALCOMN QCP®-860 (insert make/model#), a satellite telephone such as a GlobalStar™, a personal digital assistant such as a Palm Pilot® device or Handspring Visor® device, a pager, and any other type of device for communicating in a wireless fashion. Wireless communications device 18 may be notebook-sized or pocket-sized to enhance the portability of the device. Wireless communications device 18 includes at least the appropriate system logic 34, including hardware and software, for wireless communications with communications network 16. For example, system logic 34 includes a communications program for transferring and displaying data between wireless device 18 and communications network 16. Further, for example, system logic 34 may include the appropriate executable programs and drivers enabling data transfer between wireless device 18 and peripheral devices 14 and base module 12 in combination with communications network 16. Additionally, for example, system logic 34 may include one or more browser programs and associated hardware for transferring and displaying data from one or more communications networks 16 accessed through wireless connection 20.

Wireless connection 20 may be any wireless communications system as described above with regard to communications network 16. For example, wireless connection 20 may include a mobile communications system, a satellite communications system, a radio wave communications system, and an optical wave communications system, among others. As such, wireless connection 20 may be one of a combination of networks associated with communications network 16.

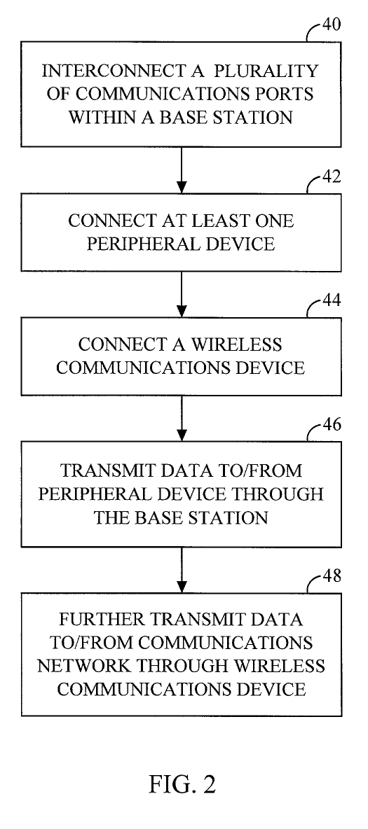

In operation, referring to FIG. 2, one embodiment of a method of interfacing a plurality of peripheral devices with a communications network includes interconnecting a plurality of communications ports mounted within a base module (Block 40). The plurality of communications ports including a wireless device port and at least one peripheral port, where the wireless device port is operable for providing a communications link with the communications network, and where the at least one peripheral device port is operable for providing a communications link to the wireless device port. At least one of a plurality of peripheral devices is connected to the peripheral device port (Block 42). A wireless communications device is connected to the wireless device port (Block 44). Then, data is transmitted for communication with the communications network to and from the at least one peripheral device through the base module (Block 46). Further, the data is transmitted through the wireless communications device to and from the communications network (Block 48). The communication of the data to and from the combination of the base module, peripheral device and wireless device may be enabled by a browser program and a driver program each associated with either the base module, the wireless device, or a combination of both. The browser program being operable for communicating with the communications network, while the driver program being operable for enabling communication between the browser program and the at least one peripheral device. The various peripheral device ports and the wireless device port may be of a standard configuration so that modular peripheral devices and wireless devices, respectively, may be detachedly connected to the base module. The peripheral devices providing additional or enhanced features, when compared to the wireless communications device, for communicating with the communications network. The wireless device providing a wireless communication method that allows the base module to be a portable, hand-held device. Thus, the communications method provided by this embodiment combines a standardized and modular base module with the convenience and portability of a wireless communications device and with the additional and/or enhanced features of one or more peripheral devices to provide a robust system for interacting with a communications network.

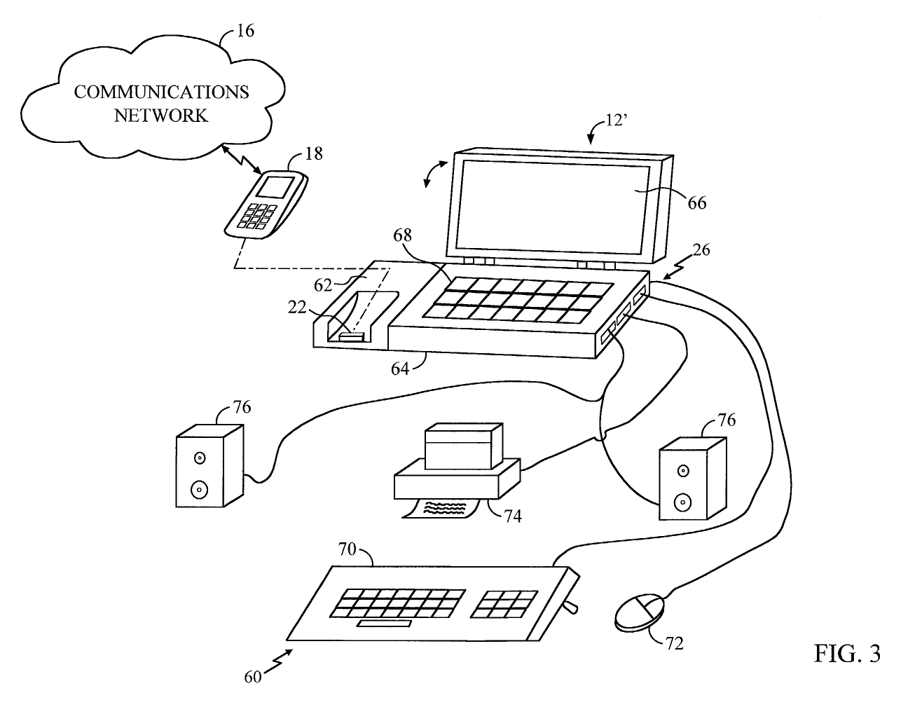

Referring to FIG. 3, where like reference numbers designate like features, another embodiment of a system 60 for communicating with a communications network 16 includes portable base module 12′ having docking port 62 for receiving and holding wireless communications device 18. Docking port 62 includes wireless device port 22 for establishing a communications link between wireless device 18 and base module 12′. Docking port 62 may be integrated with housing 64 of base module 12 or the docking port may be a separate, attachable unit. Alternatively, system 60 may include a connection device such as a cable to detachably connect wireless communications device 18 and base module 12′. Additionally, base module 12′ includes an integrated display 66, such as a back-lit LCD display, and input device 68, such as a virtual or physical alphanumeric keypad. Further, a number of external peripheral devices may be detachably connected to base module 12′ at peripheral ports 26, such as keyboard 70 and mouse 72 for inputting information, printer 74 for outputting graphical and alphanumeric information, and audio speakers 76 for outputting sound.

In this embodiment, for example, base module 12′ is a portable unit having a larger display and keyboard than wireless device 18, thereby facilitating a user's ability to exchange data with communications network 16, such as the Internet accessed through a wireless communications system. Further, for example, system logic 34 (FIG. 1) of wireless device 18 includes communications hardware and software for communicating with a wireless communications system, as well as communications software for communicating with, for example, the Internet and its World Wide Web protocol. Additionally, for example, system logic 34 (FIG. 1) of wireless device 18 includes the appropriate logic and driver programs for interacting with base module 12′, display 66, keyboard 68 and the other external peripheral devices. In this case, where system logic 34 (FIG. 1) of wireless device 18 is utilized for all communications and data exchange, base module 12′ may be a “dumb” terminal that includes the hardware for interconnecting the various devices. Although, it should be noted that base module 12′ may contain additional hardware and software to assist or complement the functionality of wireless device 18. Sized as a portable unit, base module 12′ may be conveniently carried around by a user along with wireless communications device 18, thereby providing the user with remote access to, for example, the Internet while providing more convenient functionality than the wireless device for communicating with the Internet. As such, base module 12′ functions as a “webstation.”

In other embodiments, systems 10 and 60 or variations thereof may include the base module and a number of peripheral devices fixedly attached to the base module. For example, there may be a full-sized monitor, such as one having a 12 inch or greater screen size, and a full-sized keyboard and a printer attached to the base module. The base module and attached peripheral devices may then be fixedly attached to a kiosk or other structure located in a public area, such as in an airport or a mall. Then, for a fee user may connect their wireless communications device to the base module to communicate with the communications network, such as the Internet. Many other similar applications may be found for the systems and methods of the present invention.

Thus, the base module provides a plurality of data connections and communications structure to interconnect a wireless communication device with one or more peripheral devices to form a modular system for communicating with a communications network. Some peripheral devices, such as a display, may be integral with the base module while other peripheral devices and the wireless communications device may be detachably connected to the base module to form a portable system. Therefore, the base module, peripherals and wireless communications device define a detachable and interconnectable system for wirelessly communicating with a communications network.

The previous description of embodiments of the present invention are provided to enable any person skilled in the art to make or use the invention. The various modifications to these embodiments will be readily apparent to those skilled in the art, and the generic principles defined herein may be applied to other embodiments without the use of the inventive faculty. Thus, the present invention is not intended to be limited to the embodiments disclosed herein but is to be accorded the widest possible scope consistent with the principles and novel features disclosed herein and recited by the following claims.

What we claim as our invention is

What is claimed is:

1. A system for communication with a communications network, comprising:
a base module including a plurality of communications ports, the plurality of communications ports including a wireless device port and at least one peripheral device port, wherein the wireless device port is operable for providing a communications link with the communications network, and wherein the at least one peripheral device port is operable for providing a communications link to the wireless device port; and
at least one peripheral device connectable to the corresponding at least one peripheral device port, the at least one peripheral device providing output data or receiving input data in communication with the communications network through the base module.

2. The system of claim 1, further comprising a browser program and a driver program each associated with the base module, the browser program operable for communicating with the communications network, the driver program operable for enabling communication between the browser program and the at least one peripheral device.

3. The system of claim 1, further comprising a wireless communications device connectable to the wireless device port, the wireless communications device operable to communicate with the communications network.

4. The system of claim 3, wherein the wireless communications device comprises a browser program and a driver program, the browser program operable for communicating with the communications network, the driver program operable for enabling communication between the wireless communications device and the at least one peripheral device.

5. The system of claim 1, wherein the wireless communications device is selected from the group consisting of a mobile phone, a satellite phone, a personal digital assistant, and a pager device.

6. The system of claim 1, wherein the at least one of the plurality of peripheral devices is selected from the group consisting of a keyboard, a display device, an audio speaker, a memory device, an alarm system, and a television controller device.

7. The system of claim 1, wherein the communications network is selected from the group consisting of a public communications network and a private communications network.

8. The system of claim 1, wherein the communications network comprises the Internet.

9. The system of claim 1, wherein the at least one peripheral device includes a predefined feature for providing an improved capability, with respect to a wireless communications device, for communicating with the communications network.

10. The system of claim 9, wherein the predefined feature for providing an improved capability, with respect to a wireless communications device, is selected from the group consisting of a larger keyboard input area, a larger display area, and an improved audio system.

11. The system of claim 9, further comprising a wireless communications device detachably connectable to the wireless device port, the wireless communications device operable to communicate with the communications network, wherein the at least one peripheral device is integral with the base module, and wherein the base module is sized for hand-held portability.

12. A system for communication with a communications network, comprising:
a base module including a plurality of communications ports, the plurality of communications ports including a wireless device port and at least one peripheral port;
at least one of a plurality of peripheral devices connectable to the at least one peripheral port, the at least one peripheral device providing output data or receiving input data in communication with the communications network through the base module; and
a wireless communications device connectable to the wireless device port, the wireless communications device operable to communicate with the communications network.

13. The system of claim 12, wherein the wireless communications device further comprises at least one communications program, the communications program operable for enabling communication with the communications network and the one of the plurality of peripheral devices.

14. The system of claim 13, wherein the at least one communications program includes an Internet browser program.

15. The system of claim 12, wherein the base module further comprises at least one communications program, the communications program operable for enabling communication with the communications network and the one of the plurality of peripheral devices.

16. The system of claim 15, wherein the at least one communications program includes an Internet browser program.

17. The system of claim 12, wherein the wireless communications device is selected from the group consisting of a mobile phone, a satellite phone, a personal digital assistant, and a pager device.

18. The system of claim 12, wherein the communications network is selected from the group consisting of a public communications network and a private communications network.

19. The system of claim 18, wherein the communications network comprises the Internet.

20. The system of claim 12, wherein the at least one peripheral devices is selected from the group consisting of a keyboard, a display device, an audio speaker, a memory device, an alarm system, and a television controller device.

21. The system of claim 20, wherein the at least one peripheral device further comprises a predefined feature for providing an improved capability, with respect to the wireless communications device, for communicating with the communications network.

22. The system of claim 21, wherein the predefined feature for providing an improved capability, with respect to the wireless communications device, is selected from the group consisting of a larger keyboard input area, a larger display area, and an improved audio system.

23. The system of claim 12, wherein the wireless communications device is detachably connectable to the wireless device port, wherein the at least one peripheral device is integral with the base module, and wherein the base module is sized for hand-held portability.

24. A method of interfacing a plurality of peripheral devices with a communications network, comprising:
interconnecting a plurality of communications ports mounted within a base module, the plurality of communications ports including a wireless device port and at least one peripheral port, where the wireless device port is operable for providing a communications link with the communications network, and where the at least one peripheral device port is operable for providing a communications link to the wireless device port; and
transmitting data for communication with the communications network to and from at least one peripheral device through the base module, the at least one peripheral device connected to the peripheral device port.

25. The method of claim 24, further comprising communicating with the communications network utilizing a browser program and a driver program each associated with the base module, the browser program operable for communicating with the communications network, the driver program operable for enabling communication between the browser program and the at least one peripheral device.

26. The method of claim 24, further comprising communicating with the communications network utilizing a wireless communications device connectable to the wireless device port.

27. The method of claim 26, where the wireless communications device comprises a browser program and a driver program, the browser program operable for communicating with the communications network, the driver program operable for enabling communication between the wireless communications device and the at least one peripheral device.

28. The method of claim 24, where the wireless communications device is selected from the group consisting of a mobile phone, a satellite phone, a personal digital assistant, and a pager device.

29. The method of claim 24, where the at least one peripheral device is selected from the group consisting of a keyboard, a display device, an audio speaker, a memory device, an alarm system, and a television controller device.

30. The method of claim 24, where the communications network is selected from the group consisting of a public communications network and a private communications network.

31. The method of claim 30, where the communications network comprises the Internet.

32. The method of claim 24, wherein the at least one peripheral device includes a predefined feature for providing an improved capability, with respect to a wireless communications device, for communicating with the communications network.

33. The method of claim 32, where the predefined feature for providing an improved capability, with respect to a wireless communications device, is selected from the group consisting of a larger keyboard input area, a larger display area, and an improved audio system.

34. The method of claim 24, further comprising communicating with the communications network with a wireless communications device detachably connected to the wireless device port, where the at least one peripheral device is integral with the base module, and where the base module is sized for hand-held portability.

35. A method of interfacing a plurality of peripheral devices with a communications network, comprising:
interconnecting a plurality of communications ports mounted within a base module, the plurality of communications ports including a wireless device port and at least one peripheral port, where the wireless device port is operable for providing a communications link with the communications network, and where the at least one peripheral device port is operable for providing a communications link to the wireless device port;
transmitting data for communication with the communications network to and from at least one peripheral device through the base module, the at least one peripheral device connected to the peripheral device port; and
establishing a communications link with the communications network utilizing a wireless communications device connectable to the wireless device port.

36. The method of claim 35, further comprising communicating with the communications network utilizing a browser program and a driver program each associated with the base module, the browser program operable for communicating with the communications network, the driver program operable for enabling communication between the browser program and the at least one peripheral device.

37. The method of claim 35, further comprising communicating with the communications network utilizing the wireless communications device connected to the wireless device port.

38. The method of claim 37, where the wireless communications device comprises a browser program and a driver program, the browser program operable for communicating with the communications network, the driver program operable for enabling communication between the wireless communications device and the at least one peripheral device.

39. The method of claim 35, where the wireless communications device is selected from the group consisting of a mobile phone, a satellite phone, a personal digital assistant, and a pager device.

40. The method of claim 35, where the at least one peripheral device is selected from the group consisting of a keyboard, a display device, an audio speaker, a memory device, an alarm system, and a television controller device.

41. The method of claim 35, where the communications network is selected from the group consisting of a public communications network and a private communications network.

42. The method of claim 41, where the communications network comprises the Internet.

43. The method of claim 35, wherein the at least one peripheral device includes a predefined feature for providing an improved capability, with respect to a wireless communications device, for communicating with the communications network.

44. The method of claim 43, where the predefined feature for providing an improved capability, with respect to a wireless communications device, is selected from the group consisting of a larger keyboard input area, a larger display area, and an improved audio system.

45. The method of claim 24, further comprising communicating with the communications network with the wireless communications device detachably connected to the wireless device port, where the at least one peripheral device is integral with the base module, and where the base module is sized for hand-held portability.
